(19) United States
(12) Patent Application Publication
(10) Pub. No.: US 2004/0257915 A1
(43) Pub. Date: Dec. 23, 2004

(54) Accessory and watch

(76) Inventor: Shigeru Miyama, Chiba-shi (JP)

Correspondence Address: ADAMS & WILKS, 31st Floor, 50 Broadway, New York, NY, 10004, US

(21) Appl. No.: 10/793,283

(22) Filed: Mar. 4, 2004

(30) Foreign Application Priority Data
Mar. 14, 2003 (JP) 2003-069767

(51) Int. Cl. G04B 37/00; G04B 39/00

(52) U.S. Cl. 368/280

(57) ABSTRACT

To provide an accessory and a watch that neither necessitates a contact surface for obtaining necessary strength nor peels with time, and can decorate a titanium material and/or a titanium alloy material. On a surface of an exterior case for use in a watch that uses a titanium material as a material, an aluminum material is spray coated to dispose a spray coated layer. The aluminum material of the spray coated layer is disposed so as to be a top surface and an upper side surface of the exterior case for a wrist watch. In portions where the durability and the corrosion resistance are required, for instance, a back surface portion that comes into contact with skin during transportation and portions that are likely to be contaminated by perspiration and dirt, the spray coated layer is removed. Thereafter, the alumite treatment is applied onto the remaining spray coated layer.

### BACKGROUND OF THE INVENTION

1. Field of the Invention

The present invention relates exterior parts and watches.

2. Description of the Prior Art

In conventional accessories, when a pure titanium material and/or a titanium alloy material is used as a decorating material, a concavity is disposed on a surface of a watchcase made of the pure titanium material and/or titanium alloy material. In the concavity, an accessory member made of an aluminum material and/or an aluminum alloy material is fixed. After fixing, the surface of the watchcase is subjected to the anodic oxidation, followed by removing an oxide film by use of mechanical means or chemical means. At this time, an oxide film formed on the watchcase is thinner than that formed on the accessory member, accordingly, an anode oxidation film can be applied only on the accessory member (for instance, JP-A No. 7-3495).

A pure titanium material and/or a titanium alloy material, because of excellent characteristics such as high mechanical strength, light weight, high corrosion resistance and high metal allergy resistance, is used in many products including accessories such as exterior parts for portable wrist watches and so on. In the case of decoration due to plating, since the color is limited to gold color, gray color and black color, variety of product needs cannot be responded. Furthermore, in the case of pure titanium material, by means of the anodic oxidation, the coloration can be relatively freely applied; however, since a film is thin and less corrosion resistant, there is a problem in that it cannot be applied to parts for which the durability is demanded.

As to an aluminum material, an excellent corrosion-proof technology, namely, anodic oxidation process can be applied. The anodic oxidation film combines excellent corrosion resistance, wear resistance and coloring properties, accordingly, is adopted in all including exterior parts for portable watches that use the pure aluminum material or aluminum alloy material. However, once the anodic oxidation film is broken for some reasons, perspiration or seawater causes strong corrosion. In particular, in the case of exterior parts for portable watches, the corrosion is much caused in a back surface portion, a winder portion, a band-engaging portion and a band piece linkage portion all that come into contact with skin and are likely to be contaminated by perspiration and dirt. The corrosion rapidly proceeds and likely to damage the exterior parts for portable watch.

In the case of these materials being used in combination in a product to heighten partial decoration and function, so far, after the completion of parts, these are fixed by use of an adhesive and so on; alternatively the titanium material is partially processed in concavity, an aluminum part is pressure inserted into this concavity, and thereafter the anodic oxidation is applied. However, in the method where the parts are fixed by use of the adhesive and so on, there is a problem in that in order to obtain necessary mechanical strength, an adhesion area is necessary and peeling is caused with time. In the method where the pressure insertion is used to fix, since there are restrictions on a shape, the method is only partially adopted.

### SUMMARY OF THE INVENTION

The accessories according to the present invention include a pure titanium material and/or a titanium alloy in which among a sprayed layer obtained by spray coating an aluminum material on a surface, the sprayed layer other than decoration portions is removed, thereafter the anodic oxidation process is applied, and thereby an anodic oxidation film is formed.

Furthermore, in the accessories according to the invention, the sprayed layer is formed with the concavity obtained by processing the surface in concavity buried by the spray coating.

Still furthermore, in the accessories according to the invention, the aluminum melt plating is applied on the surface to form a aluminum melt plating layer followed by spray coating the aluminum material.

Furthermore, in the accessories according to the invention, after the anodic oxidation film is formed, the compressive forging is applied.

Still furthermore, the accessories according to the invention are subjected to heat treatment at a temperature of 450 degree centigrade or more and 600 degree centigrade or less.

A watch according to the invention includes a case that uses these accessories, a back cover that engages with the case and a movement that is accommodated inside of the case and displays time.

### BRIEF DESCRIPTION OF THE SEVERAL VIEWS OF THE DRAWINGS

A preferred form of the present invention is illustrated in the accompanying drawings in which:

FIG. 1 is an explanatory diagram schematically showing a section of a winder portion of a watch involving the invention;

FIG. 2 is an explanatory diagram schematically showing a section of a band engaging portion of a watch involving the invention; and

FIG. 3 is an explanatory diagram schematically showing a state when an accesory involving the invention is used as an exterior part for a portable watch.

### DETAILED DESCRIPTION OF THE PREFERRED EMBODIMENTS

Accessories and watches according to the present invention take advantages of, owing to the use of a pure titanium material and/or a titanium alloy material as a material, excellent properties such as high mechanical strength, light weight, high corrosion resistance and high metal allergy resistance, and take advantages of excellent corrosion resistance, wear resistance and coloring properties of an anodic oxidation film that are characteristic of an aluminum material. With an intention of improving the decorativeness of the pure titanium material or the titanium alloy material that is a material, an aluminum material is coated by means of a plasma spray coating method to a thickness of 100 μm or more.

Thereafter, in a band-engaging portion and band pieces linkage portion that are necessary to be high in the corrosion resistance and mechanical strength, a back surface portion that comes into contact with skin and tends to be contaminated by the perspiration and dirt, a winder portion and so on, the sprayed layer unnecessary for the decoration is removed and the anodic oxidation is applied.

At this time, an anodicoxidation thickness of the aluminum spraycoated layer is set at 10 μm or more, and the anodicoxidation conditions are controlled so that all of the aluminum material that is the spray coated layer may not be an alumite layer (Al₂O₃), that is, the aluminum spray coated layer may remain at a boundary with the titanium material or the titanium alloy material.

The reason for the aluminum spray coated layer being left at the boundary is present in that since the alumite layer (Al₂O₃) that is formed by the anodic oxidation is hard and brittle, when all is rendered to the alumite layer, the adhesiveness with titanium material, titanium alloy material that are a material becomes poor, resulting in peeling off.

When the aluminum melt plating is applied prior to the spray coating of an aluminum material, an aluminum diffusion layer is formed at an interface with a titanium material and thereby the adhesiveness of the spray coated layer can be further improved.

When the smoothness and coloring properties of the alumite layer are necessary, the spray coated layer is necessarily improved in the density. Accordingly, after the spray coating, the forging is applied.

Furthermore, when, after the forging, the heat treatment is applied in the range of from 450 to 600 degree centigrade for from 30 to 20 minutes, an alumite layer that is not different from a pure aluminum material can be obtained. The choice of these depends on cost and required quality.

As a result, when portions necessary for decoration are colored to necessary colors by the anodic oxidation of the sprayed layer of the aluminum material and portions necessary to be high in the corrosion resistance and the mechanical strength of material are processed so as to be a titanium material or a titanium alloy, exterior parts for portable watches excellent in the corrosion resistance, durability and decorability can be provided.

An exterior part for a portable wristwatch according to the invention will be explained with reference to the drawings.

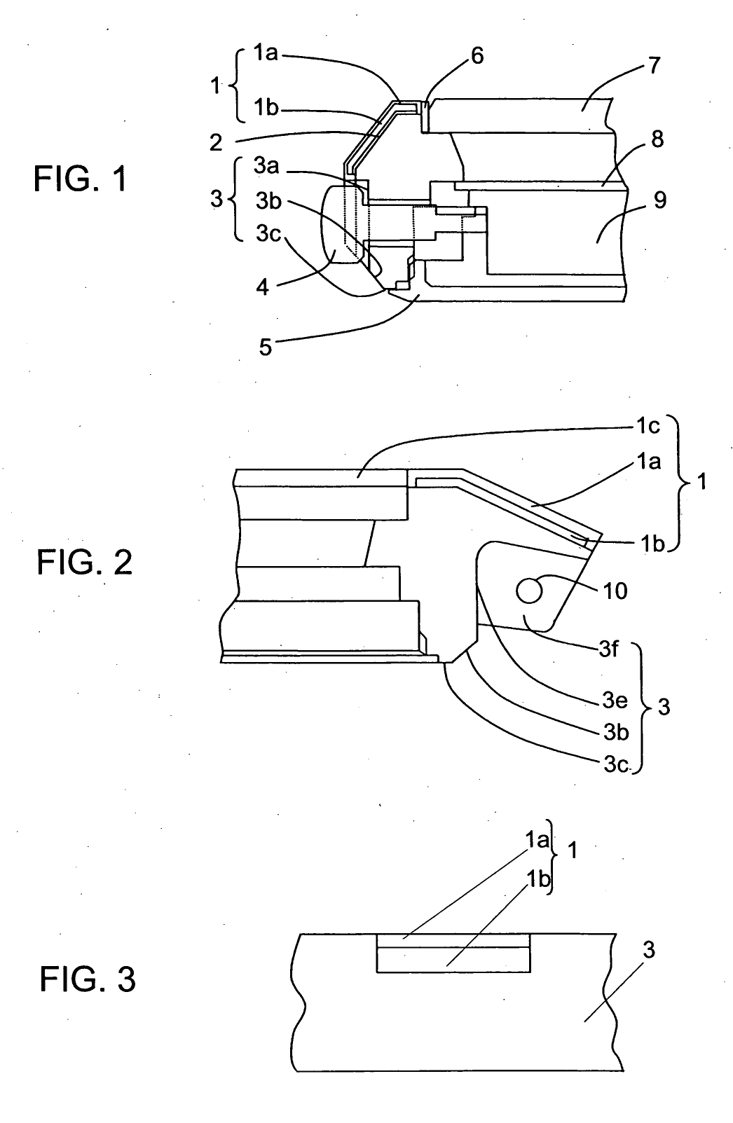

FIG. 1 is a schematic sectional explanatory diagram of a winder portion in a watch according to the invention.

After a case 3 that is an exterior part for a portable watch is processed from a titanium material, an aluminum melt plating layer 2 is applied. Furthermore, an aluminum material is spray coated to place an aluminum spray coated layer 1 on a surface of the aluminum melt plating layer 2 at a top surface and a side surface.

At this time, so that in portions required to be high in the corrosion resistance and mechanical strength of material that are necessary. for the exterior part for a portable watch, a winder bottom portion 3a, a back surface portion 3b, a back cover contact portion 3c and so on that come into contact with skin and are likely to be contaminated by perspiration and dirt, a titanium material may be disposed, an unnecessary layer of the aluminum spray coated layer is removed.

Thereafter, an alumite process la is applied to a depth of 10 μm or more from a surface layer of the aluminum spray coated layer 1 so that a remainder lb of the pure aluminum spray coated layer 1 may be 10 μm or more. A movement 9 to which a clock face 8 is fixed is disposed inside of a case 3. A glass fixing packing 6 is fixed to a step portion disposed at an upper portion of the case 3. Glass 7 is fixed by pressing the glass fixing packing 6. A back cover 5 is fixed by engaging with a bottom surface of the case 3. The winder 4 is disposed sideward to the case 3 and connected to the movement 9. As a result, since the alumite layer of the aluminum spray coated layer improves the decorativeness and the titanium material contributes to the durability and the corrosion resistance, an excellent exterior part for a portable watch can be provided.

FIG. 2 is a sectional explanatory diagram of a band engaging portion of a case part that is an exterior part for a portable watch to which the anodic oxidation is applied after an aluminum material is spray coated on an exterior part for a portable watch. A case 3 that is an exterior part for a portable watch is processed from a titanium material. Thereafter, a pure aluminum material is spray coated to dispose the aluminum spray coated layer 1 on a surface portion of a top surface and a side surface. At this time, so that portions required to be high in the corrosion resistance and mechanical strength of material that are necessary for the exterior part for a portable watch, and band engaging portions 3e, 3f, a band attachment hole 10 and back surface portions 3b, 3c that come into contact with skin and are likely to be contaminated by perspiration and dirt may become a titanium material, an unnecessary aluminum layer is removed.

Thereafter, the alumite treatment 1a is applied up to a depth of 10 μm or more of a surface layer of the aluminum spray coated layer 1 so that the remainder 1b of the aluminum spray coated layer 1 may be 10 μm or more. The alumite treatment is applied also to a portion where the glass is inserted and to an alumite treatment layer 1c of glass insertion diameter portion.

As a result, the alumite processed layer improves the decorativeness and the titanium material portion contributes to the durability and the corrosion resistance of the band engaging portion; accordingly, an excellent exterior part for a portable watch can be provided.

FIG. 3 is an explanatory diagram where an exterior part for use in a portable watch to which the anodic oxidation is applied after an aluminum material is spray coated to the exterior part for a portable watch is partially processed into a concavity followed by applying decoration. With a titanium material, a portion necessary to be decorated of a case part 3 that is an exterior part for a portable watch is processed into a concavity. A pure aluminum material is spray coated on the concave portion so as to be the same level or more followed by forging. Thereafter, the polishing is applied so as to be the same level as the titanium, and the alumite treatment la is applied to a depth of 10 μm or more of the surface layer of the spray coated layer 1 so that the remainder 1b of the spray coated layer 1 may remain 10 μm or more.

As a result, an exterior part for a portable watch that can display a pattern and is excellent in the decorativeness can be provided.

The present invention involving an exterior part for a portable watch in which an aluminum material is spray coated and a spray coated layer is subjected to anodic oxidation, as explained above, can provide an exterior part for a portable watch that combines excellent decorativeness of the aluminum material and high mechanical strength, light weight, corrosion resistance and metal allergy resistance of the titanium material.

What is claimed is:

1. An accessory made of a pure titanium material and/or a titanium alloy material on which surface an aluminum material is spray coated to form a spray coated layer, among the spray coated layer, the spray coated layer other than a decoration portion is removed, thereafter anodic oxidation is applied to form an anodic oxidation film.

2. An accessory as set forth in claim 1:
wherein the spray coated layer is formed with a concavity formed by processing the surface in concavity buried by spray coating.

3. An accessory as set forth in claim 1:
wherein after the surface is subjected to aluminum melt plating to form an aluminum melt plating layer, the aluminum material is spray coated..

4. An accessory as set forth in claim 1:
wherein after the anodic oxidation film is formed, compressive forging is applied.

5. An accessory as set forth in claim 1:
wherein heat treatment is applied at a temperature equal to 450 degree centigrade or more and equal to 600 degree centigrade or less.

6. A watch including:
a case that uses an accessory made of a pure titanium material and/or a titanium alloy material on which surface an aluminum material is spray coated to form a spray coated layer, among the spray coated layer, the spray coated layer other than a decoration portion is removed, thereafter anodic oxidation is applied to form an anodic oxidation film;
a back cover that engages with the case; and
a movement that is accommodated inside of the case and displays time.
